(19) United States
(12) Patent Application Publication
(10) Pub. No.: US 2025/0331077 A1
(43) Pub. Date: Oct. 23, 2025

(54) Multi-Wavelength RGB LED Technology for Enhanced Color Rendering

(71) Applicant: Karl S. Jonsson, Rancho Santa Margarita, CA (US)

(72) Inventor: Karl S. Jonsson, Rancho Santa Margarita, CA (US)

(21) Appl. No.: 19/180,054

(22) Filed: Apr. 15, 2025

Related U.S. Application Data
(60) Provisional application No. 63/635,505, filed on Apr. 17, 2024.

(51) Int. Cl. H05B 45/12; F21K 9/69; H05B 45/325; H05B 45/335; H05B 47/11; H05B 47/155

(52) U.S. Cl. CPC H05B 45/12; F21K 9/69; H05B 45/325; H05B 45/335; H05B 47/11; H05B 47/155

(57) ABSTRACT

A device may include a first light-emitter having a first spectral output and a second light-emitter having a second spectral output both configured to have their brightness controlled by a first signal of the lighting apparatus. A device may include a third light-emitter having a third spectral output configured to have its brightness controlled by a second signal of the lighting apparatus. The first spectral output, the second spectral output, and the third spectral output are all different from one another.

### CROSS-REFERENCE TO RELATED APPLICATIONS FIELD

This application claims the benefit of U.S. Provisional Application 63/635,505 filed Apr. 17, 2024, entitled “Multi-Wavelength RGB LED Technology for Enhanced Color Rendering of Colored LEDs,” which is hereby incorporated by reference in its entirety herein for any and all purposes.

### TECHNICAL FIELD

The disclosed subject matter relates to variable color lighting technology.

### BACKGROUND

The current market predominantly features red-green-blue (RGB) and red-green-blue-white (RGBW) light-emitting diode (LED) configurations controlled using static pulse-width modulation (PWM) or pulse-frequency modulation (PFM) outputs from a 3 or 4 channel LED controller for variable-color LED lights and in some cases by using integrated circuit (IC) controllers like the WS2811, WS2812, and UCS2904B for addressable LED lights with variable color. These systems limit each primary color, red, green, and blue, to a narrow spectrum of wavelengths, which often results in poor color quality and rendering. Specifically, these LEDs fail to cover extensive parts of the visible spectrum, significantly limiting the fidelity of color representation and making it challenging to produce quality white light and subtle color tones.

FIG. 1 represents the wavelengths emitted by some existing solutions. The spectrum 110 shows the light output of an implementation using traditional red, green, and blue LEDs emitting narrow bands of red light 113, green light 112, and blue light 111, respectively. In these traditional implementations, the red, green, and blue LEDs may be separately modulated to simulate different colors to the human visual system.

The first generation of Philips® HUE® light bulbs utilized a mix of narrow-spectrum LEDs (red and royal blue) and a wide-spectrum phosphor-based lime-green LED as shown in the spectrum 130. The lime-green channel, serving as a broad-spectrum component of green light 122, was designed to enrich the overall white light quality. This configuration allowed for the intensity of the red light 123 emitted by the red LEDs and blue light 121 emitted by the royal-blue LEDs to be adjusted through standard 3-channel RGB color mixing, facilitating the creation of both warm and cool white tones. Additionally, this approach achieved high-contrast tones in red, blue, and magenta. However, it compromised the green channel, which tended to blur adjacent spectral regions due to the broad emission of the phosphor.

For improved white light quality, phosphor or YAG (yttrium aluminum garnet)-coated LEDs are often integrated as a fourth channel (RGBW) as shown in the spectrum 130. Each of the four LEDs could be individually controlled, with the red LED providing red light 133, the green LED providing green light 132, the blue LED providing blue light 131, and the “white” LED providing a broad-spectrum of light 134. While this approach enhances white light, it does not substantially improve the spectrum quality for many hues.

Advanced solutions in the market have introduced additional individually controlled color channels in an attempt to improve the spectrum coverage and color fidelity. Notable among these is the Visiolite® Vibrance™ LED system which incorporates deep red, amber, cyan, and indigo (DACI) LEDs in combination with standard red, green and blue LEDs. This system allows for seven-channel color mixing, utilizing narrow bandwidth colors to achieve superior color resolution by providing a broader spectrum for color mixing, but it requires specialized control systems to handle the additional channels, which are not compatible with standard RGB or RGBW controllers.

Another sophisticated approach is the Omni-Color technology from HIVE Lighting®. This technology provides wide color gamut control using multiple LEDs across different wavelengths. It integrates a blend of up to seven LED colors to achieve an exceptionally broad spectrum, allowing for precise color tuning and high-quality light output across diverse applications. Despite its versatility, the Omni-Color technology also necessitates the use of custom controllers and is typically geared towards professional lighting environments, which limits its accessibility for general consumer use.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute part of the specification, illustrate various embodiments. Together with the general description, the drawings serve to explain various principles. In the drawings:

FIG. 1 shows example spectrum outputs of three different combinations of LEDs that have traditionally been used in a multi-LED lighting apparatus;

FIG. 2 is a schematic of an example of a multi-LED lighting apparatus;

FIG. 3 shows an output spectrum consistent with the implementation of the multi-LED lighting apparatus shown in FIG. 2;

FIG. 4 is a schematic of an alternative example of a multi-LED lighting apparatus;

FIG. 5 is a schematic of another alternative example of a multi-LED lighting apparatus;

FIG. 6 shows an example of an LED strip using alternating 5050 RGBW chips in a pixel cluster;

FIG. 7 shows an example of an LED lighting apparatus using eight individual LEDs per pixel cluster;

FIG. 8 is a schematic of an example of an LED lighting apparatus using 5 different LEDs; and

FIG. 9 is a flow diagram of a method to generate a specified color of light.

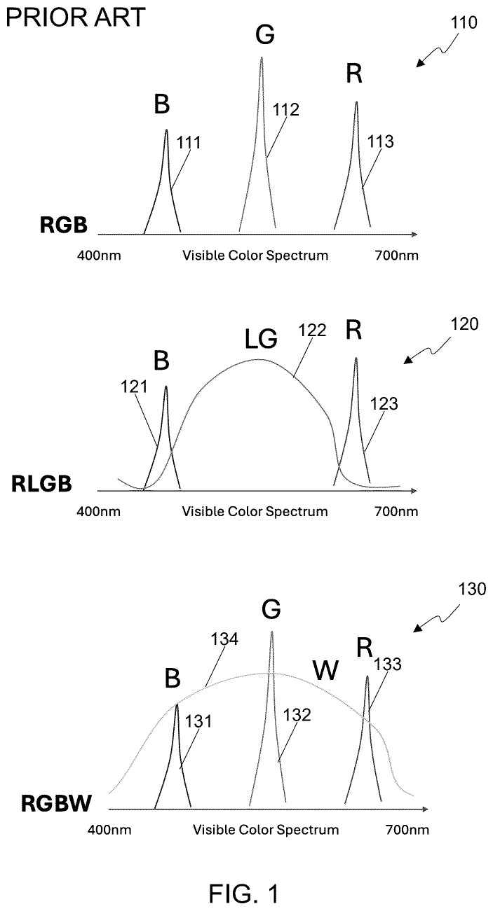

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures and components have been described at a relatively high level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

In the past, there have been numerous attempts to enhance the color rendering index (CRI) for white light from LED-based lights, employing strategies such as custom phosphor blends and alternative substrates like UV-based GaN on GaN to reduce the blue spike in the white light spectrum. However, there have been fewer efforts to improve the color rendering index (CRI) for colored LED lights, strips and other LED applications. Previous methods have typically relied on proprietary controllers or LED drivers. The methods, systems, and apparatuses described herein represent a novel approach by significantly enhancing the CRI for colored lighting without tradeoffs using phosphors or the need for specialized controllers and/or drivers.

The color rendering index (CRI) of a lighting apparatus utilizing RGB LEDs may be enhanced by incorporating multiple narrow bandwidth LEDs for each primary color channel, without individually controlling the multiple LEDs within each band. This technology can improve the quality of color reproduction in applications where high-fidelity color representation is advantageous, such as in art, theatrical settings, and high-end ambient lighting. Prior solutions provide inadequate color rendering due to their use of standard RGB LEDs which individually provide narrow parts of the visible spectrum. Standard multi-channel controllers are commonly limited to three or four channels, further complicating the ability to enhance color quality without resorting to custom, costly solutions.

Solutions described herein resolve these limitations by utilizing multiple distinct emitters for each color channel in an LED array. For example, two or more red LEDs emitting different wavelengths of light, such as ˜580 nanometers (nm) and ˜630-680 nm, may be used for the red channel and controlled as a monolithic source of red light. Similarly two or more green LEDs emitting different wavelengths of light, such as ˜520 and ˜540 nm, may be used for the green channel and controlled as a monolithic source of green light, and/or two or more blue LEDs emitting different wavelengths of light, such as ˜405 nm and ˜465 nm, may be used for the blue channel and controlled as a monolithic source of blue light. Using multiple narrowband LEDs within a single-color band allows for a fuller coverage of that color's spectrum. This approach allows for the same granularity in color mixing as RGB but with improved color rendering across the spectrum without the need for specialized controllers and keeping the high contrast and dynamic range without the use of wide, muddy phosphors. Some implementations may include a fourth channel with one or more amber (or some other band in the visible spectrum) LEDs.

The present disclosure describes a multi-wavelength RGB LED lighting apparatus designed to significantly improve the color rendering index (CRI) and spectral accuracy of colored LED-based lighting systems without relying on phosphor coatings or specialized controllers. This is achieved by combining multiple narrowband LEDs within each RGB color channel, while remaining compatible with standard RGB, RGBW, and RGBA controllers. Systems, as described herein, deliver higher spectral fidelity, better color mixing, and enhanced CRI compared to standard RGB or RGBW systems. They can do this without the need for custom controllers, as standard 3- or 4-channel PWM controllers, including those used in DMX decoders, can be used to control such a system. As such, the technology can be used in standard addressable LED strips and fixtures using standard serial control ICs such as WS2811, UCS8904B, and others. This allows vibrant, dynamic pixel-based displays and video representation.

Some implementations may utilize a fourth channel for one or more amber LEDs, such as LEDs emitting light in the range of 570-615 nm for enhanced vibrancy in warm tones using a red-green-blue-amber (RGBA) configuration. Other implementations may utilize the fourth channel to drive a phosphor-based white LED, such as a YAG white LED, for standard RGBW applications. Some implementations may include additional channels to drive one or more LEDs in other specific color bands or additional white LEDs with different color temperatures.

Various implementations may provide a significantly improved color rendering index for a colored LED system as compared to prior solutions, enabling more accurate color representation in various applications. Implementations may be able to utilize existing off-the-shelf controllers, reducing the need for specialized or proprietary systems. The disclosed solutions can be implemented in small-scale applications (e.g., home lighting) or large-scale installations (e.g., theatrical lighting) without extensive modifications.

In general, an LED lighting apparatus can include a plurality of controllable channels that are separately controlled depending on the target color output of the apparatus. At least one of the channels is used to drive a plurality of LEDs having different spectral outputs within a spectral range for that channel.

The following paragraphs describe the accompanying drawings, which illustrate various aspects of the disclosure.

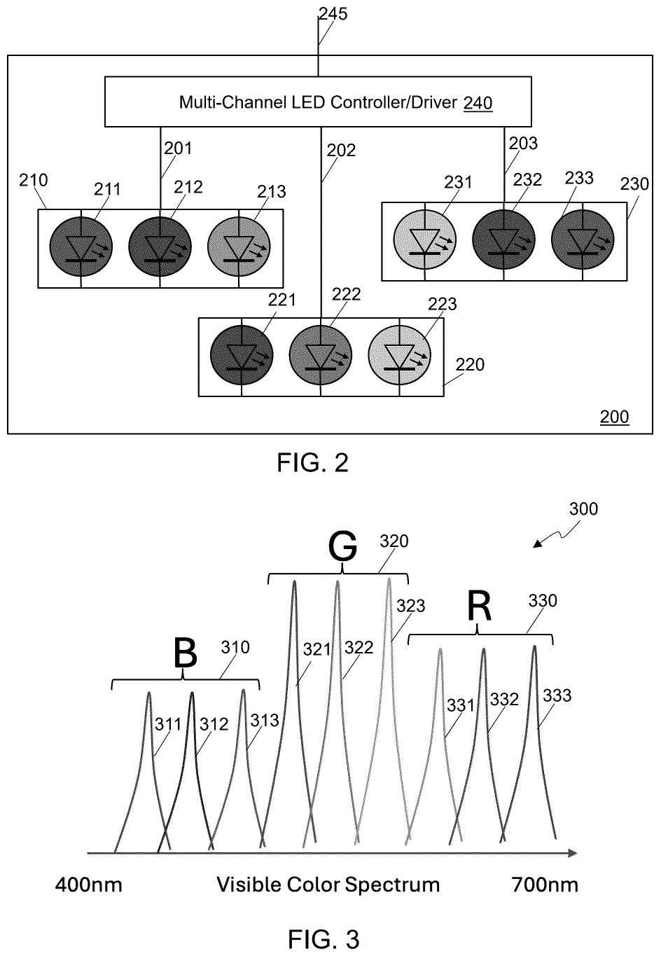

FIG. 2 is a schematic of an example of a multi-LED lighting apparatus 200, which may be referred to as a Visolite Wide RGB, or a Visiolite ChromaX™ lighting apparatus, and FIG. 3 shows an output spectrum 300 consistent with the example multi-LED lighting apparatus 200 shown in FIG. 2. In the example lighting apparatus 200, the composite spectral output of three LEDs are used for each of the three color channels, but other implementations may have different numbers of color channels and use any number of LEDs for each of channel, as long as two or more LEDs are used for at least one channel.

Lighting apparatus 200 includes a first set of LEDs 210 which emit light in a first spectral band for a first channel, a second set of LEDs 220 which emit light in a second spectral band for a second channel, and a third set of LEDs 230 which emit light in a third spectral band for a third channel. In the implementation shown, the first channel may be referred to as a blue channel and the first spectral band 310 may be referred to generally as blue light, the second channel may be referred to as a green channel and the second spectral band 320 may be referred to generally as green light, and the third channel may be referred to as a red channel and the third spectral band 310 may be referred to generally as red light. Thus, the first spectral band 310, the second spectral band 320 and the third spectral band 330 may each be uniquely selected from the group consisting of red wavelengths of light, green wavelengths of light, and blue wavelengths of light. Other implementations may divide the spectrum into different bands.

The first set of LEDs 210 includes a first blue LED 211 which emits light at a first wavelength 311 in the first spectral band 310, a second blue LED 212 which emits light at a second wavelength 312 in the first spectral band 310, and a third blue LED 213 which emits light at a third wavelength 313 in the first spectral band 310. Other implementations may include any number of LEDs in the first set of LEDs 210. Note that the three blue LEDs 211, 212, 213 may emit light which may not be exactly “blue” but may be perceived as violet, indigo, turquoise, cyan, or other colors, as long as they have a peak output that is within the first spectral band 310. The exact wavelengths for the first spectral band 310 may vary depending on the implementation, but in at least one example, wavelengths in the first spectral band 310 may be a range of 499 nm to 380 nm.

The second set of LEDs 220 includes a first green LED 221 which emits light at a first wavelength 321 in the second spectral band 320, a second green LED 222 which emits light at a second wavelength 322 in the second spectral band 320, and a third green LED 223 which emits light at a third wavelength 323 in the second spectral band 320. Other implementations may include any number of LEDs in the second set of LEDs 220. Note that the three green LEDs 221, 222, 223 may emit light which may not be exactly “green” but may be perceived as cyan, olive, chartreuse, yellow, or other colors, as long as they have a peak output that is within the second spectral band 320. The exact wavelengths for the second spectral band 320 may vary depending on the implementation, but in at least one example, wavelengths in the second spectral band 320 may be a range of 565 nm to 500 nm.

The third set of LEDs 230 includes a first red LED 231 which emits light at a first wavelength 331 in the third spectral band 330, a second red LED 232 which emits light at a second wavelength 332 in the third spectral band 330, and a third red LED 233 which emits light at a third wavelength 333 in the third spectral band 330. Other implementations may include any number of LEDs in the third set of LEDs 230. Note that the red LEDs 231, 232, 233 may emit light which may not be exactly “red” but may be perceived as maroon, rust, pink, orange, amber, or other colors, as long as they have a peak output that is within the third spectral band 330. The exact wavelengths for the third spectral band 330 may vary depending on the implementation, but in at least one example, wavelengths in the third spectral band 330 may be a range of 780 nm to 566 nm.

As described, the three spectral bands 310, 320, 330 are non-overlapping. Other implementations may have spectral bands that overlap, however. Thus, an implementation could include a cyan LED in both the first set of LEDs 210 and the second set of LEDs 220.

The lighting apparatus 200 generates three wavelengths per color band to improve the color rendering index (CRI). As a non-limiting example, the first set of LEDs 210 may include a first LED 211 emitting light 311 at 405 nm, a second LED 211 emitting light 312 at 435 nm, and a third LED 213 emitting light 313 at 465 nm, spanning a broad blue spectrum to enhance blue tones and contribute to accurate purple and indigo mixes. The second set of LEDs 220 may include a first LED 221 emitting light 321 at 500 nm, a second LED 222 emitting light 322 at 520 nm, and a third LED 223 emitting light 323 at 540 nm, offering a range of green shades that contribute to both vivid greens and more nuanced mixed colors. And the third set of LEDs 230 may include a first LED 231 emitting light 331 at 580 nm, a second LED 232 emitting light 332 at 630 nm, and a third LED 233 emitting light 333 at 680 nm, covering a broad range of the red spectrum to provide rich and deep red tones.

The lighting apparatus 200 also includes a multi-channel LED controller/driver 240 (i.e. a controller 240). The controller 240 may be a single integrated circuit or may be a collection of circuitry interconnected using conductors and/or a printed circuit board, depending on the implementation. The controller 240 has an input 245 through which it may receive color and/or brightness information for the lighting apparatus 200. The controller 240 has a first output 201 to provide a first signal which is used to drive the first set of LEDs 210 as a first monolithic unit so that the composite spectral output of the first set of LEDs 210 is controlled by the first output 201, a second output 202 to provide a second signal which is used to drive the second set of LEDs 220 as a second monolithic unit so that the composite spectral output of the second set of LEDs 220 is controlled by the second output 202, and a third output 203 to provide a third signal which is used to drive the third set of LEDs 230 as a third monolithic unit so that the composite spectral output of the third set of LEDs 230 is controlled by the third output 203. The first signal provided by the first output 201, the second signal provided by the second output 202, and the third signal provided by the third output 203, may be PWM or PFM modulated, voltage-regulated, or current-regulated to respectively provide a particular amount of power to each of the first set of LEDs 210, the second set of LEDs 220, and the third set of LEDs 230.

An alternative lighting apparatus may also include a fourth output of the controller 240 which may receive brightness/color information for a fourth channel, and a fourth set of LEDs. The fourth set of LEDs may include one or more LED having a peak output in a fourth spectral band, such as amber light. In this alternative example, the first (blue) spectral band includes wavelengths of 499 nm to 380 nm, the second (green) spectral band includes wavelengths of 565 nm to 500 nm, the fourth (amber) spectral band includes wavelengths of 615 nm to 566 nm, and the third (red) spectral band includes wavelengths of 780 nm to 616 nm.

In the example shown in FIG. 3, the lighting apparatus 200 receives brightness/color information through its input 245 indicating that and the blue channel should be driven to 60% brightness, the green channel should be driven to 90% brightness, and the red channel should be driven to 75% brightness. It then generates a first signal on the first output 201 that is modulated to a level corresponding to 60% brightness for the first set of LEDs 210 and provided to those three LEDs 211, 212, 213, a second signal on the second output 202 that is modulated to a level corresponding to 90% brightness for the second set of LEDs 220 and provided to those three LEDs 221, 222, 223, and a third signal on the third output 203 that is modulated to a level corresponding to 75% brightness for the third set of LEDs 230 and provided to those three LEDs 231, 232, 233. The relationship between the brightness/color information may be non-linear due to the output efficiency curves of the LEDs, human perception of color/brightness, and/or other factors.

While each set of LEDs 210, 220, 230 is driven as a single unit, the level at which each LED in a set is driven may vary according to design parameters and/or calibration settings that are determined during the design of the lighting apparatus 200, the manufacture of a specific unit of the lighting apparatus 200, or at a later calibration of a specific unit of the lighting apparatus 200. This may be due to different efficiencies of the various LEDs in a set, a desired spectral profile for the spectral band, variations between individual LEDs of the same type, or other factors. In some implementations, the LEDs within a set may be matched with a specific series resistor to tune the current drawn by the LED. The resistor/LED pairs of a set of LEDs tuned in this way may be wired in parallel. This allows for tuning during design and/or manufacture but cannot be easily changed during a later calibration process. In other implementations, the controller 240 may have individual outputs for each LED in a set of LEDs that are controlled together based on the color/brightness information received through the input 245 but can be individually calibrated. So, as a non-limiting example, if the controller 240 receives a brightness of 50% for the green channel, instead of modulating all of its outputs for the set of green LEDs 220 to 50%, it may use calibration information stored in the controller 240 (or in an external memory coupled to the controller 240) to determine that the first LED 221 should be driven at 48%, the second LED 222 should be driven at 55%, and the third LED 223 should be driven at 40% to achieve the proper spectral output from the green set of LEDs. Note, however, that the input 245 does not provide individual brightness information for individual LEDs within a set of LEDs that are assigned to a channel or color band.

The lighting apparatus 200 may take numerous physical forms, including being integrated into a light bulb or luminaire, being packaged as a part of an LED strip or a multi-die package, being assembled onto a printed circuit board, or any other appropriate physical form.

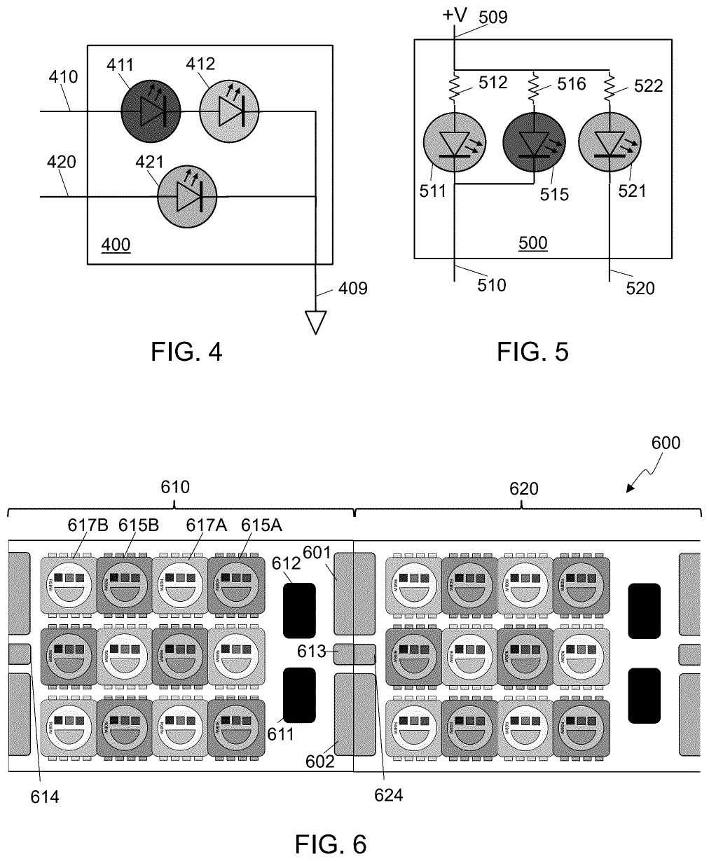

FIG. 4 is a schematic of an alternative example of a multi-LED lighting apparatus 400. The lighting apparatus 400 includes a first light-emitter 411 having a first spectral output and a second light-emitter 412 having a second spectral output both configured to have their brightness controlled by a first signal 410 of the lighting apparatus 400. The lighting apparatus 400 also includes a third light-emitter 421 having a third spectral output configured to have its brightness controlled by a second signal 420 of the lighting apparatus 400. In some implementations, the first light-emitter 411 may be a first light-emitting diode (LED), the second light-emitter 412 may be a second LED, and the third light-emitter 421 may be a third LED.

The first spectral output of the first light-emitter 411, the second spectral output of the second light-emitter 412, and the third spectral output of the third light-emitter 421 are all different from one another. The first spectral output of the first light-emitter 411 and the second spectral output of the second light-emitter 412 are both in a first spectral band, such red light or blue light. The third spectral output of the third light-emitter 421 is in a second spectral band, such as green light.

In the example shown, the first signal 410 of the lighting apparatus 400 may be a first modulated power signal and the second signal 420 of the lighting apparatus 400 may be a second modulated power signal. The first light-emitter 411 and the second light-emitter 412 are coupled in series to the first modulated power signal, and the third light-emitter 421 is coupled to the second modulated power signal. The first modulated power signal and the second modulated power signal may be, as non-limiting examples, pulse-width modulated, pulse-frequency modulated, or constant-current regulated, and provide current through the light emitters 411, 412, 421 to the ground connection 409 to cause the light emitters 411, 412, 421 to emit light.

Implementations may include additional LEDs respectively coupled to the first signal 410 and/or the second signal 420. Implementations may also or alternatively include additional LEDs coupled to additional signals received by the lighting apparatus 400.

FIG. 5 is a schematic of another alternative example of a multi-LED lighting apparatus 500. The lighting apparatus 500 includes a first light-emitter 511 having a first spectral output and a second light-emitter 515 having a second spectral output both configured to have their brightness controlled by a first signal 510 of the lighting apparatus 500. The lighting apparatus 500 also includes a third light-emitter 521 having a third spectral output configured to have its brightness controlled by a second signal 520 of the lighting apparatus 500. In some implementations, the first light-emitter 511 may be a first light-emitting diode (LED), the second light-emitter 515 may be a second LED, and the third light-emitter 521 may be a third LED.

The first spectral output of the first light-emitter 511, the second spectral output of the second light-emitter 515, and the third spectral output of the third light-emitter 521 are all different from one another. The first spectral output of the first light-emitter 511 and the second spectral output of the second light-emitter 515 are both in a first spectral band, such red light or blue light. The third spectral output of the third light-emitter 521 is in a second spectral band, such as green light.

The first light-emitter 511 is coupled in series with resistor 512 and the second light-emitter 515 is coupled in series with resistor 516. Resistance values of resistor 512 and resistor 515 may be set at design time based on efficiency curves (i.e. light output versus current flow) of the first light-emitter 511 and the second light-emitter 515 to provide a balanced light output for the color of light being generated by the first light-emitter and the second light-emitter. Alternatively, resistance values of resistor 512 and resistor 516 may be set at manufacture time based on testing/calibration of the lighting apparatus. The third light-emitter 521 is coupled in series with resistor 522 whose resistance value may be determined at design time or at manufacture time.

In the example shown, the first signal 510 of the lighting apparatus 500 may be a first modulated power signal and the second signal 520 of the lighting apparatus 500 may be a second modulated power signal. The first light-emitter 511 with its resistor 512 is coupled in parallel with the second light emitter 515 with its resistor 516. The two parallel-coupled light-emitters 511, 515 are then coupled to the first modulated power signal (first signal 510), and the third light-emitter 521 is coupled to the second modulated power signal (second signal 520). The first modulated power signal and the second modulated power signal may be, as non-limiting examples, pulse-width modulated, pulse-frequency modulated, constant-current regulated, or constant-voltage regulated, and sink current through the light emitters 411, 412, 421 from the positive voltage connection 509 to cause the light emitters 511, 515, 521 to emit light.

Implementations may include additional LEDs respectively coupled to the first signal 510 and/or the second signal 520. Implementations may also or alternatively include additional LEDs coupled to additional signals received by the lighting apparatus 500.

FIG. 6 shows an example of an LED strip 600 using alternating 5050 RGBW chips in pixel clusters. The strip 600 can include any number of sections, connected together, such as the first section 610 and the second section 610. In the implementation shown, each section 610, 620 has a power line 601 and ground line 602 that connect to both of their adjacent sections. Section 610 has a serial data input 613 connected to a serial data output 624 of an adjacent section 620, and a serial data output 614. In some implementations, the serial data output 614 of section 610 may be directly connected to, or just have a buffered version of, the serial data input 613 of that section 610, but in other cases a controller 611 may be used to daisy chain the serial data between the input 613 and the output 614. In some implementations, the controller 611 may modify the data received through the serial data input 613 before passing the modified data to the serial data output 614, such as removing data used to control the LEDs for its section.

As a non-limiting example, in light strip 600, half of the chips (type 1—shown in darker grey) such as 5050 RGBW chip 615A and 5050 RGBW chip 615B, include a red LED at 600 nm, a green LED at 510 nm and a blue LED at 405 nm. Some implementations may also include an amber LED at 560 nm. The other half of the chips (type 2—shown in lighter grey) such as 5050 RGBW chip 617A and 5050RGBW chip 617B include a red LED at 670 nm, a green LED at 540 nm and a blue LED at 450 nm. Both types of chips may or may not include a phosphor-based white LED. Other spectral compositions within each broad color range may be used in other implementations. Each section 610, 620, or pixel, on the example strip 600 includes six type 1 RGBW chips including chip 615A and chip 615B, six type 2 RGBW chips including chip 617A and chip 617B, and a controller 611 which receives the data from the serial data input 613 and sends data out through the serial data output 614. In various implementations, the controller 611 may be an USC8904B, a WS2811, or any other appropriate type of controller. In at least one implementation, the light strip 600 may be a high brightness wide spectrum addressable light strip supporting lengths over 20 meters at 48V. In some implementations, a power circuit 612 may be required to allow the 12 LEDs to be driven from each of the 3 outputs (or 4 outputs if white LEDs are included) of the controller 611, although other implementations may not require the power circuit 612 but may be able to drive a full set of LEDs for that section from each output of the controller 611.

In the first section 610 of the example light strip 600, the controller 611 receives a serial data stream from the serial data input 613 and extracts a red brightness value, a green brightness value, a blue brightness value, and in some implementations, a white brightness value from the serial data stream. It then passes the serial data stream to the serial data output 614. In some implementations, it may remove the brightness values that it extracted from the serial data stream before passing the edited serial data stream to the output 614.

The controller 611 then generates a modulated red signal based on the red brightness value, a modulated green signal based on the green brightness value, a modulated blue signal based on the blue brightness value, and, if included, a modulated white signal based on the white brightness value which it sends to the power circuitry 612. The power circuitry 612 generates an amplified red signal from the modulated red signal to sink current from the set of 12 red LEDs of the 12 5050 RGBW chips, an amplified green signal from the modulated green signal to sink current from the set of 12 green LEDs of the 12 5050 RGBW chips, an amplified blue signal from the modulated blue signal to sink current from the set of 12 blue LEDs of the 12 5050 RGBW chips, and if included, an amplified white signal from the modulated white signal to sink current from the set of 12 white LEDs of the 12 5050 RGBW chips.

The Visiolite ChromaX™ LED strip uses a similar implementation to that shown in FIG. 6, although with both a warm white (2200K) and a cold white (4000K) phosphor-based LED is included in each multi-LED package in addition to the red, green, and blue LEDs. The Visiolite ChromaX™ has red LEDs at 625 nm and 665 nm, green LEDs at 525 nm and 545 nm, and blue LEDs at 465 nm and 450 nm.

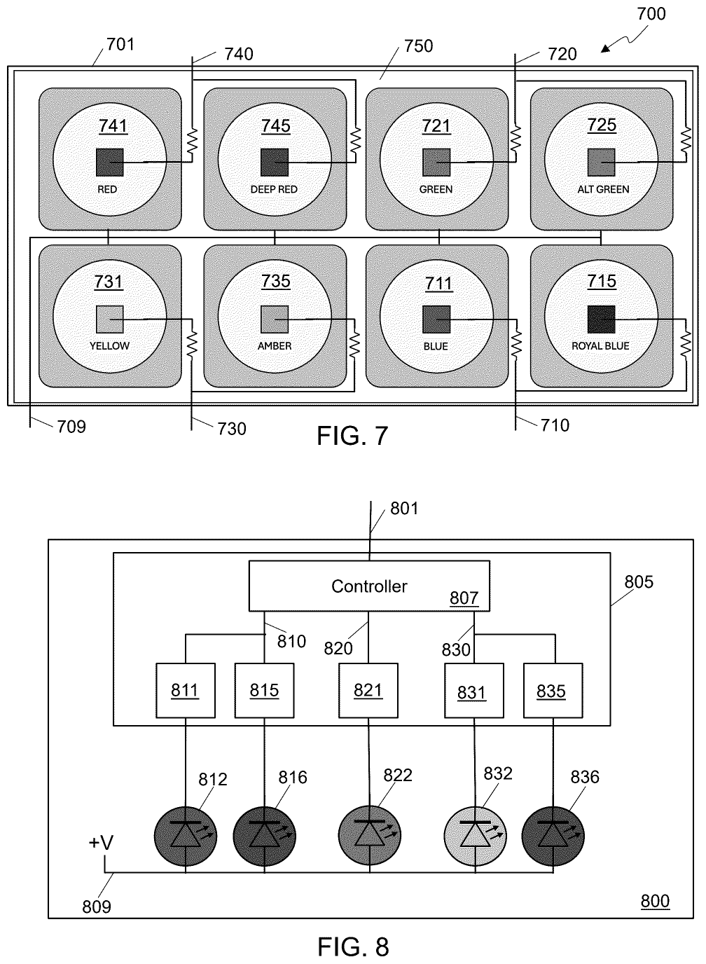

FIG. 7 shows an example of an LED lighting apparatus 700 using eight individual LEDs per pixel cluster, with one pixel cluster 701 shown. The lighting apparatus 700 may include a plurality of pixel clusters, including a first pixel cluster 701, that each have a set of red LEDs, a set of amber LEDs, a set of green LEDs, and a set of blue LEDs, where each set of LEDs has one or more LEDs and the set of LEDs for at least one color has two or more LEDs.

As shown, the pixel cluster 701 of the example lighting apparatus 700 includes a red LED 741 and a deep red LED 745 that can be driven in parallel from red input 740, a yellow LED 731 and an amber LED 735 that can be driven in parallel from amber input 730, a green LED 721 and an alternate green LED 725 that can be driven in parallel from green input 720, and a blue LED 711 and a royal blue LED 715 that can be driven in parallel from blue input 710. Each of the LEDs 741, 745, 731, 735, 721, 725, 711, 715 is also coupled to a power input 709 to provide a current path from the inputs 740, 730, 721, 710 through the LEDs 741, 745, 731, 735, 721, 725, 711, 715.

Each LED 741, 745, 731, 735, 721, 725, 711, 715 has an associated resistor. The value of each resistor may be determined at design time based on the efficiency curve for its associated LED and the target light output for that LED as a part of the composite spectral output for its channel. In some cases, testing/calibration may be performed on individual LEDs during the manufacturing of the lighting apparatus 700 to determine the resistor value to use based on the target light output for that LED and the individual LED's characteristics. As a non-limiting example, the Table 1 below shows a full-on forward operating current (Icc) in milliAmps (mA) and voltage (Vf) and typical light output in millicandelas (mcd) for the 8 LEDs used in the lighting apparatus 700. It also shows a target light output determined at design time for the how much light that LED should contribute to the composite spectral output for its channel.

TABLE 1

| | Icc | Vf | Output | Target | Resistor |
|---|---|---|---|---|---|
| LED | (mA) | (V) | (mcd) | (mcd) | (Ohms) |
| Royal Blue 715 | 75 | 3.2 | 1200 | 1200 | 5.3 |
| Blue 711 | 70 | 3.2 | 1200 | 1200 | 5.7 |
| Alt Green 725 | 60 | 3.0 | 2700 | 1500 | 18 |
| Green 721 | 50 | 3.0 | 2700 | 1000 | 32 |
| Yellow 731 | 55 | 2.4 | 2000 | 1100 | 40 |
| Amber 735 | 60 | 2.4 | 2500 | 1400 | 36 |
| Red 741 | 80 | 2.0 | 1800 | 1200 | 30 |
| Deep Red 745 | 90 | 2.0 | 1800 | 1800 | 18 |

The resistor value is calculated to provide that amount of light output based on a linear interpolation of the current and using a 3.6 V power source (Vs) are also shown using the formula below, where Icc is in Amperes (not mA) and the power source (Vs) is set to be 3.6 V. Note that LEDs typically have nonlinear efficiency curves with somewhat varying forward voltage which could be used for the calculation in implementations, but a linear interpolation with a constant forward voltage is used here for simplicity.

$$R = \frac{( Vs - Vf )}{( Icc \times \frac{Target}{Output} )}$$

The values shown are purely illustrative and implementations may have different target output levels depending on their intended use. Models of the human visual system and the eye's sensitivity to various wavelengths of light may be used as well as testing of systems using various resistor settings with a variety of human subjects. It has been found, for example, that in the red channel example shown, a composite spectral output with more light from the deep red LED 745 than the red LED 741 may provide a more pleasing output due to the human eye's lower sensitivity to the longer wavelength from the deep red LED 745 as compared to the red LED 741.

The lighting apparatus 700 can have any number of pixel clusters, such as pixel cluster 701, depending on the implementation. The lighting apparatus 700 can have any appropriate form factor, including an LED strip divided into sections, similar to that shown in FIG. 6, with one pixel cluster per section. Another implementation of the lighting apparatus 700 may organize pixel clusters in a two-dimensional array to allow an image to be displayed.

The pixel cluster 701 may be covered by, or integrated into, an optical element 750, which may include lenses, diffusers, reflectors, mixing chambers, or any other type of optical component, to provide visually seamless color blending. The material for the optical element 750 may be free of UV-reactive additives to prevent unwanted lumifluorescent effects from near-ultraviolet light which may be present from near-UV or violet LEDs.

The pixel cluster 701 may be constructed from individual LEDs with their own packaging as shown in FIG. 7, with each package mounted on a substrate for that cluster 701. Each cluster of the apparatus 700 may be separately packaged and then joined together, or the apparatus may mount LEDs for a plurality of pixel clusters on a single substrate. A pixel cluster may alternatively use multi-LED packages, such as a 5050 package similar to that shown in FIG. 6 or may use thin-film or other technologies to directly create a plurality of LEDs on a single substrate, such as an array of organic LEDs.

The lighting apparatus 700 may be driven from a red/green/blue/amber LED controller/driver such as NXP's PCA9957 or Texas Instruments' TLC59208F that has at least 4 output driver channels. This allows for a broad range of colors to be accurately represented which improves performance in ambient, architectural, and skin tone-critical applications.

FIG. 8 is a schematic of an example of an LED lighting apparatus 800 using 5 different LEDs. Due to the dominant visual sensitivity of the human eye to green, and the limited perceptual differentiation between green wavelengths, it has been discovered that adequate performance may be obtained using a single narrowband green LED or a wide-band lime green LED, while using two or more LEDs with different wavelengths for each of the red and blue channels as the red and blue channels contribute more strongly to improved color rendering of colors.

A light-emitting diode (LED) lighting apparatus 800 includes driver circuitry 805 having a first output signal 810, a second output signal 820, and a third output signal 830. The apparatus 800 also includes a first LED 812 having a peak output at a first wavelength and a second LED 816 having a peak output at a second wavelength. The first LED 812 and the second LED 816 are both coupled to the first output signal 810 of the driver circuitry 805 and are configured to have their brightnesses controlled by the first output signal 810 to create a first composite spectral output. The apparatus 800 also includes a third LED 822 having a peak output at a third wavelength. The third LED 822 is coupled to the second output signal 820 of the driver circuitry 805 and is configured to have its brightness controlled by the second output signal 820 to create a second spectral output. The apparatus 800 also includes a fourth LED 832 having a peak output at a fourth wavelength and a fifth LED 836 having a peak output at a fifth wavelength. The fourth LED 832 and the fifth LED 835 are both coupled to the third output signal 830 of the driver circuitry 805 and are configured to have their brightnesses controlled by the third output signal 830 to create a third composite spectral output. As a non-limiting example, the first wavelength and the second wavelength may be in a first range of 760 nm to 566 nm, the third wavelength may be in a second range of 565 nm to 500 nm, and the fourth wavelength and the fifth wavelength may be in a third range of 499 nm to 380 nm and thus, the first wavelength and the second wavelength may be different shades of red light, the third wavelength may be green light, and the fourth wavelength and the fifth wavelength may be different shades of blue light.

The lighting apparatus 800 includes a serial data input 801 supporting a serial protocol to provide first data (which may also be referred to as a first signal) from a first channel of the serial protocol, second data (which may also be referred to as a second signal) from a second channel of the serial protocol, and third data (which may also be referred to as a third signal) from a third channel of the serial protocol. A controller 807 in the driver circuitry 805 is coupled to the serial data input 801 and the LEDs 812, 816, 822, 832, 836, and is configured to control brightness of the first LED 812 and the second LED 816 based on the first data, control brightness of the third LED 822 based on the second data, and control brightness of the fourth LED 832 and the fifth LED 836 based on the third data.

The definition of a channel of the serial protocol depends upon the details of the protocol. In some implementations, the serial protocol is a DMX512 protocol, and the first channel of the serial protocol is a slot of a DMX512 protocol, and the second channel of the serial protocol is a different slot of the DMX512 protocol. DMX512 protocol may refer to any version of the American National Standard (ANSI) E1.11 specification, such as DMX512-A Asynchronous Serial Digital Data Transmission Standard for Controlling Lighting Equipment and Accessories, including, but not limited to, the 2008 revision. In other implementations, the serial protocol is an I²C protocol, and the first channel is an addressable register and the second channel is a different addressable register within the address space of the controller 807. In yet other implementations, the serial protocol is an SPI protocol and the first, second and third channel are 8 bits each of the first 24 bits of data received after a reset code. The controller 807 may generate a first signal 810, a second signal 820, and a third signal 830 based on data received through the serial data input. The first signal 810, second signal 820, and third signal 830 may be electrical waveforms on a conductor that may be sent outside of the driver circuitry 805 and used to directly drive LEDs 812, 816, 822. 832, 836, or they may be kept within the driver circuitry 805 and used to generate modulated power signals to drive LEDs 812, 816, 822. 832, 836. In other cases, the first signal 810, second signal 820, and third signal 830 may be digital representations within the driver circuitry 805 which are then used to generate modulated power signals to drive the LEDs 812, 816, 822. 832, 836.

In the example LED lighting apparatus 800, the controller 807 receives a seral data stream through the serial data input 801 and extracts a first data value, a second data value, and a third data value from the serial data stream. It uses the first data value to generate a first signal 810, uses the second data value to generate a second signal 820, and used the third data value to generate a third signal 830. The driver circuitry 805 includes a first driver 811 and a second driver 815 which are coupled to the first signal 810, a third driver 821 which is coupled to the second signal 820, and a fourth driver 831 and fifth driver 835 which are coupled to the third signal 830. The first driver 811 controls the first LED 812 based on the first signal 810 and the second driver 815 controls the second LED 816 based on the first signal 810. The third driver 821 controls the third LED 822 based on the second signal 820. The fourth driver 831 controls the fourth LED 832 based on the third signal 830 and the fifth driver 835 controls the fifth LED 836 based on the third signal 830.

In some implementations calibration data is provided to the first driver 811 and the second driver 815 and is used along with the first signal 810 to respectively control the first LED 812 and the second LED 816. Calibration data may be provided to the third driver 821 which uses it along with the second signal 820 to control the third LED 822. And/or the fourth driver 831 and the fifth driver 835 may be provided with calibration data that is used along with the third signal 830 to respectively control the fourth LED 832 and the fifth LED 836. The calibration data may be stored in memory within the driver circuitry 805 or an external memory coupled to the driver circuitry 805. The calibration data may be determined during design time, at the time of manufacture, or during a calibration process. Thus, the brightness of the first LED 812, the second LED 816, the third LED 822, the fourth LED 832, and the fifth LED 836 may be calibrated to ensure consistent luminous output.

Aspects of various embodiments are described with reference to flowchart illustrations diagrams of methods disclosed herein. It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and controller instructions.

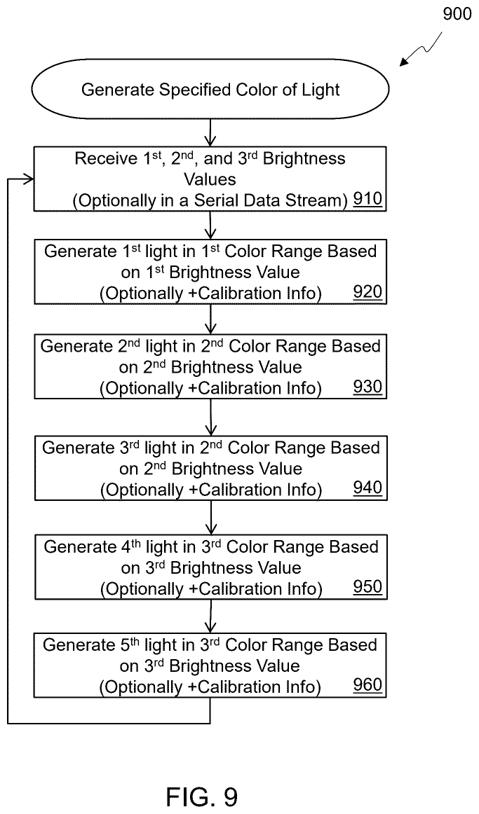

FIG. 9 is a flow diagram 900 of a method to generate a specified color of light. The method includes receiving 910 a first brightness value for a first color range and a second brightness value for a second color range, wherein the first color range and the second color range are different. It may also include receiving a third brightness value for a third color range different than the first color range and the second color range. In at least one implementation, the first color range includes green, the second color range includes red, and the third color range includes blue. The first color range, the second color range, and the third color range may be non-overlapping in some implementations.

The first brightness value, the second brightness value, and the third brightness value (if supported) may be received by any appropriate method, depending on the implementation. In some implementations, a serial data stream may be received and the first brightness value and the second brightness value extracted from the serial data stream. As one non-limiting example, the serial data stream may be compliant with a DMX512 protocol. In some cases, the serial data stream may be compatible with the serial data streams used by LED control chips such as WS2811, WS2812, UCS8904B. As other non-limiting examples, the serial data stream may be compatible with Serial Peripheral Interface (SPI), Universal Serial Bus (USB), Inter-Integrated Circuit (I²C), or any other appropriate serial communication protocol.

In some implementations, instead of receiving the brightness values in a serial data stream, the first brightness value may be provided as a first modulation level of a first signal on a first conductor of a lighting apparatus, and the second brightness value may be provided as a second modulation level of a second signal on a second conductor of the lighting apparatus. The first modulation level may be a first analog voltage level, or a first analog current level and second modulation level may be a second analog voltage level or a second analog current level. In some implementations, the first modulation level and the second modulation level may utilize pulse-width modulation or pulse-frequency modulation instead of or in addition to voltage and/or current levels.

The method also includes driving a first light-emitter based on the first brightness value to generate 920 first light having a wavelength in the first color range from the first light-emitter, driving a second light-emitter and a third light-emitter based on the second brightness value to generate 920 second light at a second wavelength in the second color range from the second light-emitter and generate 930 third light at a third wavelength, different from the second wavelength, in the second color range from the third light-emitter. Some implementations also drive a fourth light-emitter and a fifth light-emitter based on the third brightness value to generate 950 fourth light at a fourth wavelength in the third color range from the fourth light-emitter and generate 960 fifth light at a fifth wavelength, different from the fourth wavelength, in the third color range from the fifth light-emitter.

In some cases, calibration may be performed during the manufacturing process or at some other time. Calibration information may be generated during the calibration process which may describe some type of offset or function to apply to the brightness information for a type of LED or a particular LED. This calibration information can then be optionally used to ensure that the desired spectral output for each channel can be generated. Thus, the method may optionally include driving the first light-emitter, the second light-emitter, and the third light-emitter further based on the calibration information.

Examples of various embodiments are described in the following paragraphs:

Example 1. A lighting apparatus comprising: a first light-emitter having a first spectral output and a second light-emitter having a second spectral output both configured to have their brightness controlled by a first signal of the lighting apparatus; and a third light-emitter having a third spectral output configured to have its brightness controlled by a second signal of the lighting apparatus; wherein the first spectral output, the second spectral output, and the third spectral output are all different from one another.

Example 2. The lighting apparatus of example 1, wherein the first light-emitter comprises a first light-emitting diode (LED), the second light-emitter comprises a second LED, and the third light-emitter comprises a third LED.

Example 3. The lighting apparatus of example 2, wherein the first signal comprises a first modulated power signal, the second signal comprises a second modulated power signal, the first LED and the second LED are coupled to the first modulated power signal, and the third LED is coupled to the second modulated power signal.

Example 4. The lighting apparatus of example 3, wherein the first modulated power signal and the second modulated power signal are pulse-width modulated, or pulse-frequency modulated.

Example 5. The lighting apparatus of example 3, wherein the first LED and the second LED are coupled in parallel to the first modulated power signal.

Example 6. The lighting apparatus of example 3, wherein the first LED and the second LED are coupled in series to the first modulated power signal.

Example 7. The lighting apparatus of example 3, further comprising a multi-channel LED driver having a first output to provide the first signal and a second output to provide the second signal.

Example 8. The lighting apparatus of example 7, further comprising a fourth LED having a fourth spectral output, different from the first spectral output, the second spectral output, and the third spectral output, configured to have its brightness controlled by a third output of the multi-channel LED driver.

Example 9. The lighting apparatus of example 8, further comprising a fifth LED having a fifth spectral output, different from the first spectral output, the second spectral output, the third spectral output, and the fourth spectral output, configured to have its brightness controlled by a fourth output of the multi-channel LED driver.

Example 10. The lighting apparatus of example 1, further comprising: a serial data input supporting a serial protocol to provide first data from a first channel of the serial protocol and second data from a second channel of the serial protocol, wherein the first signal consists of the first data and the second signal consists of the second data; and a controller coupled to the serial data input, the first light-emitter, the second light-emitter, and the third light-emitter, and configured to control brightness of the first light-emitter and the second light-emitter based on the first data and to control brightness of the third light-emitter based on the second data.

Example 11. The lighting apparatus of example 10, wherein the serial protocol comprises a DMX512 protocol, the first channel of the serial protocol is a first slot of a DMX512 protocol, and the second channel of the serial protocol is a second slot of the DMX512 protocol.

Example 12. The lighting apparatus of example 1, further comprising: a serial data input; and a controller coupled to the serial data input, the first signal, and the second signal; wherein the first signal and the second signal are generated by the controller based on data received through the serial data input.

Example 13. The lighting apparatus of example 12, wherein the serial data input comprises a DMX512 port and the first signal is generated based on first data received in a first slot of a DMX512 data stream and the second signal is generated based on second data received in a second slot of the DMX512 data stream.

Example 14. The lighting apparatus of example 1, further comprising: a fourth light-emitter having a fourth spectral output, different from the first spectral output, the second spectral output, and the third spectral output, configured to have its brightness controlled by a third signal of the lighting apparatus, wherein the first spectral output has a first peak output and the second spectral output has a second peak output that are both in a first spectral band of visible light, the third spectral output has a third peak output in a second spectral band of visible light, and the fourth spectral output has a fourth peak output in a third spectral band of visible light; and wherein the first spectral band, the second spectral band, and the third spectral band are non-overlapping.

Example 15. The lighting apparatus of example 14, wherein the first spectral band, the second spectral band and the third spectral band are each uniquely selected from the group consisting of red wavelengths of light, green wavelengths of light, and blue wavelengths of light.

Example 16. The lighting apparatus of example 14, wherein the first spectral band, the second spectral band and the third spectral band are each uniquely selected from the group consisting of 780 nm to 566 nm wavelengths of light, 565 nm to 500 nm wavelengths of light, and 499 nm to 380 nm wavelengths of light.

Example 17. The lighting apparatus of example 14, further comprising: a fifth light-emitter having a fifth spectral output, different from the first spectral output, the second spectral output, the third spectral output, and the fourth spectral output, configured to have its brightness controlled by a fourth signal of by the lighting apparatus; wherein the fifth spectral output has a fourth peak output in a fourth spectral band of visible light; and wherein the first spectral band, the second spectral band, the third spectral band, and the fourth spectral band are non-overlapping.

Example 18. The lighting apparatus of example 17, wherein the first spectral band, the second spectral band, the third spectral band, and the fourth spectral band are each uniquely selected from the group consisting of red wavelengths of light, amber wavelengths of light, green wavelengths of light, and blue wavelengths of light.

Example 19. The lighting apparatus of example 17, wherein the first spectral band, the second spectral band, the third spectral band, and the fourth spectral band are each uniquely selected from the group consisting of 780 nm to 616 nm wavelengths of light, 615 nm to 566 nm wavelengths of light, 565 nm to 500 nm wavelengths of light, and 499 nm to 380 nm wavelengths of light.

Example 20. The lighting apparatus of example 1, further comprising: a fourth light-emitter having a fourth spectral output, different from the first spectral output, the second spectral output, and the third spectral output, configured to have its brightness controlled by the first signal; wherein the first spectral output has a first peak output, the second spectral output has a second peak output, and the fourth spectral output has a fourth peak output that are all in a first spectral band of visible light, the second spectral output has a second peak output in a second spectral band of visible light, and the third spectral output has a peak output in a third spectral band of visible light; and wherein the first spectral band, the second spectral band, and the third spectral band are non-overlapping.

Example 21. A light-emitting diode (LED) lighting apparatus comprising: driver circuitry having a first output signal, a second output signal, and a third output signal; a first LED having a peak output at a first wavelength and a second LED having a peak output at a second wavelength, the first LED and the second LED both coupled to the first output signal of the driver circuitry and configured to have their brightnesses controlled by the first output signal; a third LED having a peak output at a third wavelength, the third LED coupled to the second output signal of the driver circuitry and configured to have its brightness controlled by the second output signal; and a fourth LED having a peak output at a fourth wavelength and a fifth LED having a peak output at a fifth wavelength, the fourth LED and the fifth LED both coupled to the third output signal of the driver circuitry and configured to have their brightnesses controlled by the third output signal.

Example 22. The LED lighting apparatus of example 21, wherein the first wavelength and the second wavelength are in a first range of 780 nm to 566 nm, the third wavelength is in a second range of 565 nm to 500 nm, and the fourth wavelength and the fifth wavelength are in a third range of 499 nm to 380 nm.

Example 23. The LED lighting apparatus of example 21, wherein the first wavelength and the second wavelength are different shades of red light, the third wavelength is green light, and the fourth wavelength and the fifth wavelength are different shades of blue light.

Example 24. The LED lighting apparatus of example 23, further comprising: a plurality of pixel clusters, including a first pixel cluster comprising the first LED, the second LED, the third LED, the fourth LED, and the fifth LED, other pixel clusters of the plurality of pixel clusters respectively comprising at least two red LED, a green LED, and at least two blue LEDs.

Example 25. The LED lighting apparatus of example 23, further comprising an amber LED coupled to a fourth output signal of the driver circuitry and configured to have its brightness controlled by the fourth output signal.

Example 26. The LED lighting apparatus of example 21, wherein the first wavelength is in a first range of 680 nm to 630 nm, the second wavelength is in a second range of 590 nm to 570 nm, the third wavelength is in a third range of 540 nm to 520 nm, the fourth wavelength is in a fourth range of 475 nm to 455 nm, and the fifth wavelength is in a fifth range of 415 nm to 395 nm.

Example 27. The LED lighting apparatus of example 21, further comprising: a sixth LED having a peak output at a sixth wavelength in a sixth range of 615 nm to 566 nm, the sixth LED coupled to a fourth output signal of the driver circuitry and configured to have its brightness controlled by the fourth output signal; wherein the first wavelength and the second wavelength are in a first range of 780 nm to 616 nm, the third wavelength is in a second range of 565 nm to 500 nm, and the fourth wavelength and the fifth wavelength are in a third range of 499 nm to 380 nm.

Example 28. The LED lighting apparatus of example 21, further comprising: a serial data input; and a controller coupled to the serial data input and the driver circuitry and configured to receive a first data value, a second data value, and a third data value from the serial data input and control the driver circuitry to generate the first output signal based on the first data value, generate the second output signal based on the second data value, and generate the third output signal based on the third data value.

Example 29. The LED lighting apparatus of example 28, wherein the serial data input uses a DMX512 protocol and the first data value is received in a first slot of the DMX512 protocol, the second data value is received in a second slot of the DMX512 protocol, and the third data value is received in a third slot of the DMX512 protocol.

Example 30. The LED lighting apparatus of example 21, further comprising an optical diffuser, wherein the optical diffuser is free of UV-reactive additives to prevent unwanted lumifluorescent effects from near-ultraviolet light.

Example 31. The LED lighting apparatus of example 21, wherein brightnesses of one or more of the first LED, the second LED, the third LED, the fourth LED, and the fifth LED are calibrated to ensure consistent luminous output.

Example 32. A method of generating a specified color of light, the method comprising: receiving a first brightness value for a first color range and a second brightness value for a second color range, wherein the first color range and the second color range are different; driving a first light-emitter based on the first brightness value to generate first light having a wavelength in the first color range from the first light-emitter; and driving a second light-emitter and a third light-emitter based on the second brightness value to generate second light at a second wavelength in the second color range from the second light-emitter and third light at a third wavelength in the second color range from the third light-emitter, wherein the second wavelength and the third wavelength are different.

Example 33. The method of example 32, further comprising: receiving a third brightness value for a third color range different than the first color range and the second color range; and driving a fourth light-emitter and a fifth light-emitter based on the third brightness value to generate fourth light at a fourth wavelength in the third color range from the fourth light-emitter and fifth light at a fifth wavelength in the third color range from the fifth light-emitter, wherein the fourth wavelength and the fifth wavelength are different.

Example 34. The method of example 33, wherein the first color range includes green, the second color range includes red, and the third color range includes blue.

Example 35. The method of example 33, wherein the first color range, the second color range, and the third color range are non-overlapping.

Example 36. The method of example 32, further comprising driving the first light-emitter, the second light-emitter, and the third light-emitter further based on calibration information.

Example 37. The method of example 32, further comprising: receiving a serial data stream; and extracting the first brightness value and the second brightness value from the serial data stream.

Example 38. The method of example 37, wherein the serial data stream is compliant with a DMX512 protocol.

Example 39. The method of example 32, wherein the first brightness value is provided as a first modulation level of a first signal on a first conductor of a lighting apparatus comprising the first light-emitter, the second light-emitter, and the third light-emitter, and the second brightness value is provided as a second modulation level of a second signal on a second conductor of the lighting apparatus.

Example 40. The method of example 39, wherein the first modulation level comprises a first analog voltage level or a first analog current level and second modulation level comprises a second analog voltage level or a second analog current level.

Example 41. The method of example 39, wherein the first modulation level and the second modulation level utilize pulse-width modulation or pulse-frequency modulation.

Example 42. A lighting apparatus comprising three independently controllable light emitter channels, wherein at least one of the three channels includes two or more light emitters having different spectral outputs which are combined to produce a composite spectral output for that channel.

Example 43. The lighting apparatus of example 1, the first light-emitter and the second light-emitter coupled in parallel to the first signal; the first light-emitter comprising a first light-emitting diode (LED) coupled in series with a first resistor having a first resistance value selected based on a first target contribution of the first spectral output to a composite spectral output for the first signal; the second light-emitter comprising a second LED coupled in series with a second resistor having a second resistance value selected based on a second target contribution of the second spectral output to the composite spectral output for the first signal; and the third light-emitter comprising a third LED.

Example 45. The lighting apparatus of example 43, wherein the first resistance value and the second resistance value are selected during design of the lighting apparatus based on nominal characteristics of a first type of LED a second type of LED respectively selected for use as the first LED and the second LED.

Example 46. The lighting apparatus of example 43, wherein the first resistance value and the second resistance value are selected based on testing of the first LED and the second LED during a manufacturing process of the lighting apparatus.

Example 47. The lighting apparatus of example 43, wherein a first luminosity of the first target contribution of the first spectral output to the composite spectral output for the first signal is different than a second luminosity of the second target contribution of the second spectral output to the composite spectral output for the first signal.

As used in this specification and the appended claims, the singular forms “a”, “an”, and “the” include plural referents unless the content clearly dictates otherwise. Furthermore, as used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

The description of the various embodiments provided above is illustrative in nature and is not intended to limit this disclosure, its application, or uses. Thus, different variations beyond those described herein are intended to be within the scope of embodiments. Such variations are not to be regarded as a departure from the intended scope of this disclosure. As such, the breadth and scope of the present disclosure should not be limited by the above-described exemplary embodiments but should be defined only in accordance with the following claims and equivalents thereof.

1. A lighting apparatus comprising:
a first light-emitter having a first spectral output and a second light-emitter having a second spectral output both configured to have their brightness controlled by a first signal of the lighting apparatus; and
a third light-emitter having a third spectral output configured to have its brightness controlled by a second signal of the lighting apparatus;
wherein the first spectral output, the second spectral output, and the third spectral output are all different from one another.

2. The lighting apparatus of claim 1, wherein the first light-emitter comprises a first light-emitting diode (LED), the second light-emitter comprises a second LED, and the third light-emitter comprises a third LED.

3. The lighting apparatus of claim 2, wherein the first signal comprises a first modulated power signal, the second signal comprises a second modulated power signal, the first LED and the second LED are coupled to the first modulated power signal, and the third LED is coupled to the second modulated power signal.

4. The lighting apparatus of claim 1, further comprising:
a serial data input supporting a serial protocol to provide first data from a first channel of the serial protocol and second data from a second channel of the serial protocol, wherein the first signal consists of the first data and the second signal consists of the second data; and
a controller coupled to the serial data input, the first light-emitter, the second light-emitter, and the third light-emitter, and configured to control brightness of the first light-emitter and the second light-emitter based on the first data and to control brightness of the third light-emitter based on the second data.

5. The lighting apparatus of claim 4, wherein the serial protocol comprises a DMX512 protocol, the first channel of the serial protocol is a first slot of a DMX512 protocol and the second channel of the serial protocol is a second slot of the DMX512 protocol.

6. The lighting apparatus of claim 1, further comprising:
a serial data input; and
a controller coupled to the serial data input, the first signal, and the second signal;
wherein the first signal and the second signal are generated by the controller based on data received through the serial data input.

7. The lighting apparatus of claim 6, wherein the serial data input comprises a DMX512 port and the first signal is generated based on first data received in a first slot of a DMX512 data stream and the second signal is generated based on second data received in a second slot of the DMX512 data stream.

8. The lighting apparatus of claim 1, further comprising:
a fourth light-emitter having a fourth spectral output, different from the first spectral output, the second spectral output, and the third spectral output, configured to have its brightness controlled by a third signal of the lighting apparatus,
wherein the first spectral output has a first peak output and the second spectral output has a second peak output that are both in a first spectral band of visible light, the third spectral output has a third peak output in a second spectral band of visible light, and the fourth spectral output has a fourth peak output in a third spectral band of visible light; and
wherein the first spectral band, the second spectral band, and the third spectral band are non-overlapping.

9. The lighting apparatus of claim 8, wherein the first spectral band, the second spectral band and the third spectral band are each uniquely selected from the group consisting of red wavelengths of light, green wavelengths of light, and blue wavelengths of light.

10. The lighting apparatus of claim 8, further comprising:
a fifth light-emitter having a fifth spectral output, different from the first spectral output, the second spectral output, the third spectral output, and the fourth spectral output, configured to have its brightness controlled by a fourth signal of by the lighting apparatus;
wherein the fifth spectral output has a fourth peak output in a fourth spectral band of visible light; and
wherein the first spectral band, the second spectral band, the third spectral band, and the fourth spectral band are non-overlapping.

11. The lighting apparatus of claim 10, wherein the first spectral band, the second spectral band, the third spectral band, and the fourth spectral band are each uniquely selected from the group consisting of red wavelengths of light, amber wavelengths of light, green wavelengths of light, and blue wavelengths of light.

12. A light-emitting diode (LED) lighting apparatus comprising:
driver circuitry having a first output signal, a second output signal, and a third output signal;
a first LED having a peak output at a first wavelength and a second LED having a peak output at a second wavelength, the first LED and the second LED both coupled to the first output signal of the driver circuitry and configured to have their brightnesses controlled by the first output signal;
a third LED having a peak output at a third wavelength, the third LED coupled to the second output signal of the driver circuitry and configured to have its brightness controlled by the second output signal; and
a fourth LED having a peak output at a fourth wavelength and a fifth LED having a peak output at a fifth wavelength, the fourth LED and the fifth LED both coupled to the third output signal of the driver circuitry and configured to have their brightnesses controlled by the third output signal.

13. The LED lighting apparatus of claim 12, wherein the first wavelength and the second wavelength are different shades of red light, the third wavelength is green light, and the fourth wavelength and the fifth wavelength are different shades of blue light.

14. The LED lighting apparatus of claim 13, further comprising:
a plurality of pixel clusters, including a first pixel cluster comprising the first LED, the second LED, the third LED, the fourth LED, and the fifth LED, other pixel clusters of the plurality of pixel clusters respectively comprising at least two red LED, a green LED, and at least two blue LEDs.

15. The LED lighting apparatus of claim 13, further comprising an amber LED coupled to a fourth output signal of the driver circuitry and configured to have its brightness controlled by the fourth output signal.

16. The LED lighting apparatus of claim 12, further comprising:
a sixth LED having a peak output at a sixth wavelength in a sixth range of 615 nm to 566 nm, the sixth LED coupled to a fourth output signal of the driver circuitry and configured to have its brightness controlled by the fourth output signal;
wherein the first wavelength and the second wavelength are in a first range of 780 nm to 616 nm, the third wavelength is in a second range of 565 nm to 500 nm, and the fourth wavelength and the fifth wavelength are in a third range of 499 nm to 380 nm.

17. The LED lighting apparatus of claim 12, further comprising:
a serial data input; and
a controller coupled to the serial data input and the driver circuitry and configured to receive a first data value, a second data value, and a third data value from the serial data input and control the driver circuitry to generate the first output signal based on the first data value, generate the second output signal based on the second data value, and generate the third output signal based on the third data value.

18. The LED lighting apparatus of claim 12, further comprising an optical diffuser, wherein the optical diffuser is free of UV-reactive additives to prevent unwanted lumifluorescent effects from near-ultraviolet light.

19. The LED lighting apparatus of claim 12, wherein brightnesses of one or more of the first LED, the second LED, the third LED, the fourth LED, and the fifth LED are calibrated to ensure consistent luminous output.

20. A method of generating a specified color of light, the method comprising:
receiving a first brightness value for a first color range and a second brightness value for a second color range, wherein the first color range and the second color range are different;
driving a first light-emitter based on the first brightness value to generate first light having a wavelength in the first color range from the first light-emitter; and
driving a second light-emitter and a third light-emitter based on the second brightness value to generate second light at a second wavelength in the second color range from the second light-emitter and third light at a third wavelength in the second color range from the third light-emitter, wherein the second wavelength and the third wavelength are different.
